(19) United States
(12) Patent Application Publication
(10) Pub. No.: US 2010/0245018 A1
(43) Pub. Date: Sep. 30, 2010

(54) Thermal overload relay

(75) Inventors: Yukinari Furuhata, Konosu-shi (JP); Fumihiro Morishita, Konosu-shi (JP); Takeo Kamosaki, Konosu-shi (JP)

Correspondence Address: KANESAKA BERNER AND PARTNERS LLP, 1700 DIAGONAL RD, SUITE 310, ALEXANDRIA, VA, 22314-2848, US

(73) Assignee: FUJI ELECTRIC FA COMPONENTS & SYSTEMS, CO., LTD., Tokyo (JP)

(21) Appl. No.: 12/659,007

(22) Filed: Feb. 23, 2010

(30) Foreign Application Priority Data
Mar. 27, 2009 (JP) 2009-079396

(51) Int. Cl. H01H 61/01

(52) U.S. Cl. 337/37

(57) ABSTRACT

A thermal overload relay includes main bimetals which bend upon detection of an overload current; a release lever displaced via movement of a shifter moved in response to the bending of the main bimetals; and a contact reversing mechanism for changing-over contacts responsive to a rotation of the release lever. The main bimetals, the release lever and the contact reversing mechanism are all disposed in a case. The contact reversing mechanism includes a pivotable movable plate; a reversing spring reversing the movable plate by coupling with a rotated release lever; and an interlock plate rotating around a support shaft together with the movable plate. Each contact has a normally opened contact piece and a normally closed contact piece and is disposed respectively in the vicinity of a front surface and in the vicinity of a back surface of the interlock plate.

### BACKGROUND OF THE INVENTION AND RELATED ART STATEMENT

The present invention relates to a thermal overload relay for change-over of a contact upon detection of an overcurrent.

Patent Document 1, for example, discloses a thermal overload relay operated by detecting an overcurrent running in the main circuit.

The thermal overload relay of Patent Document 1 is described referring to FIG. 4.

This thermal overload relay comprises, in an insulator case 1 made of a resin mould, main bimetals 2 inserted in three phase electric circuit and wound with heaters 2a, a shifter 3 linked to free ends of the main bimetals 2 and movably supported on the insulator case 1, a switching mechanism 4 disposed in the insulator case 1 allowing linking to an end of the shifter 3, and a contact reversing mechanism 5 to changeover contacts by operation of the switching mechanism 4.

The switching mechanism 4 comprises a temperature compensation bimetal 7 linked to one end of the shifter 3, a release lever 8 fixed to the other end of the temperature compensation bimetal 7, and an adjusting cam 12 connected to the release lever 8 through a swinging pin 9 projecting at the lower end of the adjusting mechanism and abutting on the circumferential surface of an eccentric cam 11a of an adjusting dial 11, disposed rotatably in the insulator case 1 at the upper end of the adjusting cam 12. A rotation angle of the release lever 8 is set by varying an abutting position of the adjusting cam 12 on the circumferential surface of the eccentric cam 11a of the adjusting dial 11 through adjustment of the adjusting dial 11, thereby slightly rotating the adjusting cam 12 around a support shaft 13.

The contact reversing mechanism 5 comprises a reversing spring 14 fixed at its lower end to the release lever 8 and extending upwards, a slider 17 linking to the tip of the reversing spring 14 and moving a normally opened side movable contact piece 15b and a normally closed side movable contact piece 16a, and a reset bar 18 to manually move the slider 17 to a normal position. The reversing spring 14 is a member having a punched window (not shown in the figure) formed by punching a thin spring material, and a curved surface with a disc spring shape around the punched window. The reversing spring 14 is convexly curved towards right hand side in a normal state shown in FIG. 4.

When the bimetal 2 bends with the heat generated by the heater 2a due to an overcurrent in the above-described structure, the shifter 3 shifts to the direction indicated by the arrow P in FIG. 4 caused by displacement of the free end of the main bimetal 2. The Shift of the shifter 3 pushes a free end of the temperature compensation bimetal 7 and rotates the release lever 8 counterclockwise around the swinging pin 9.

With progression of the counterclockwise rotation of the release lever 8, the reversing spring 14 deforms bending convexly towards the left hand side. The deformation of the reversing spring 14 moves the slider 17, which is linked to the tip of the reversing spring 14, so as to change the normally opened side movable contact piece 15b and the normally opened side fixed contact piece 15a into a closed state and to change the normally closed side movable contact piece 16a and the normally closed side fixed contact piece 16b into an opened state.

Based on the information of the closed state of the normally opened side movable contact piece 15b and the normally opened side fixed contact piece 15a, and the information of the opened state of the normally closed side movable contact piece 16a and the normally closed side fixed contact piece 16b conducted by the reversing action of the switching mechanism 4, an electromagnetic contactor (not shown in the figures), for example, connected in the main circuit is opened to interrupt the overcurrent.

### [Patent Document 1]

Japanese Examined Patent Publication No. H7-001665

Meanwhile, in the contact reversing mechanism 5 of the conventional thermal overload relay described above, the slider 17 for change over of the normally opened contact (the normally opened side movable contact piece 15b and the normally opened side fixed contact piece 15a) and the normally closed contact (normally closed side movable contact piece 16a and the normally closed side fixed contact piece 16b) is placed flatly in the region over the main bimetals 2 in the insulator case 1. Moreover, the reversing spring 14 for moving the slider 17 is placed in a region different from the region for placing the slider 17. Therefore, a large space is required in, the insulator case 1, which is a problem in that it hinders a size reduction of a thermal overload relay.

In view of the above-described unsolved problems in the conventional technology examples, it is an object of the present invention to provide a thermal overload relay in which a space for placing a normally opened contact and a normally closed contact is reduced in the case, thereby minimizing the size of a thermal overload relay.

Further objects and advantages of the invention will be apparent from the following description of the invention.

### SUMMARY OF THE INVENTION

In order to accomplish the above object, a thermal overload relay according to the present invention comprises a case; main bimetals which bend upon detection of an overload current; a release lever working according to displacement of a shifter that is displaced with the bending of the main bimetals; and a contact reversing mechanism for changing-over contacts by rotation of the release lever, wherein the all three latter members are disposed in the case. The contact reversing mechanism includes a movable plate supported at a support point at one end thereof and swingably at the other end; a reversing spring stretched between the other end of the movable plate and a spring support, the other end of the movable plate and the spring support being positioned opposite each other with respect to the support point, and reversing the movable plate by coupling with a rotated release lever; and an interlock plate rotating around a support shaft together with movement of the movable plate. The contacts each have a normally opened contact piece and normally closed contact piece and are respectively disposed in the vicinity of a front surface and in a vicinity of a back surface of the interlock plate.

According to the above-stated invention, the normally opened contact and the normally closed contact are changed-over by rotation of the interlock plate. These contacts are disposed in the vicinity of the front surface and the back surface of the interlock plate. Therefore, a space for placing the contacts in this case is significantly reduced as compared with the conventional device, thereby minimizing a size of the thermal overload relay.

According to the above-stated invention, even if external disturbances such as vibration and shock occur, the movable contact piece of the contacts in a closed state effectively never separates from the fixed contact piece, thereby avoiding an improper operation of the contacts.

In the thermal overload relay according to the invention, one of the normally opened contact and the normally closed contact has the movable contact piece on the other side of the movable plate, and the change-over of the movable contact piece and the fixed contact piece is carried out by transmitting rotation of the interlock plate on the movable plate as a load for the reversing action.

According to this invention, the number of parts of the thermal overload relay is reduced, and a space for disposition of the contacts is further reduced in this case.

In a thermal overload relay according to the present invention, the normally opened contact and the normally closed contact are changed-over by rotation of the interlock plate and are disposed in the vicinity of the front surface and the back surface of the interlock plate. Therefore, a space for placing the contacts in the case is significantly reduced as compared with the conventional device, thereby minimizing the size of the thermal overload relay.

### BRIEF DESCRIPTION OF THE DRAWINGS

FIG. 1 is a drawing showing basic parts of a thermal overload relay according to the present invention in a normal state;

FIG. 2(a) is a drawing showing a contact reversing mechanism including a normally opened contact (a-contact) in the normal state;

FIG. 2(b) is a drawing showing the contact reversing mechanism including the normally opened contact (a-contact) in a tripped state;

FIG. 3(a) is a drawing showing the contact reversing mechanism including a normally closed contact (b-contact) in the normal state; and

FIG. 3(b) is a drawing showing the contact reversing mechanism including the normally closed contact (b-contact) in a tripped state;

FIG. 4 is a drawing showing essential parts of a conventional thermal overload relay in a normal state.

### DETAILED DESCRIPTION OF PREFERRED EMBODIMENTS

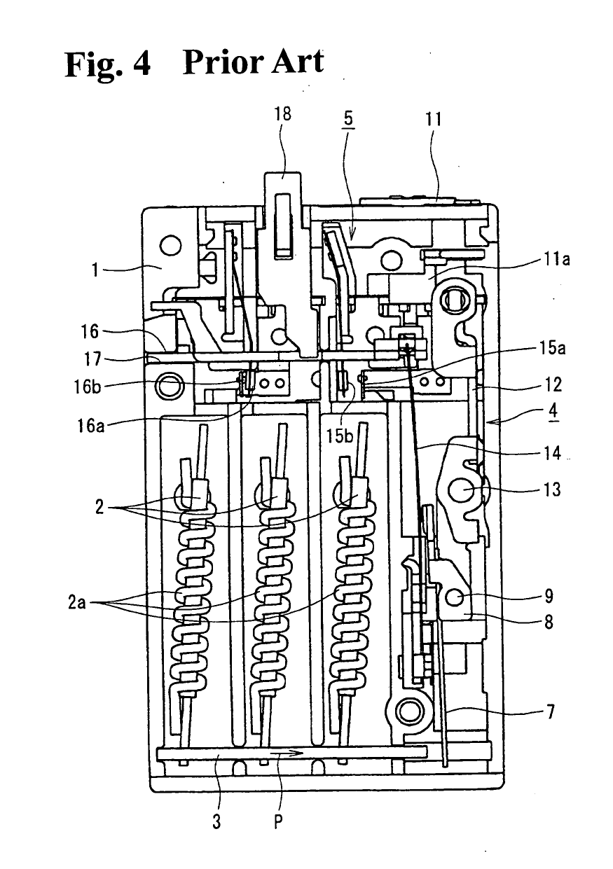

The following describes the best mode of preferred examples of embodiments of the invention in detail with reference to the accompanying drawings. The parts of the embodiment of the invention similar to the parts in FIG. 4 are denoted by the same symbols and their description is omitted.

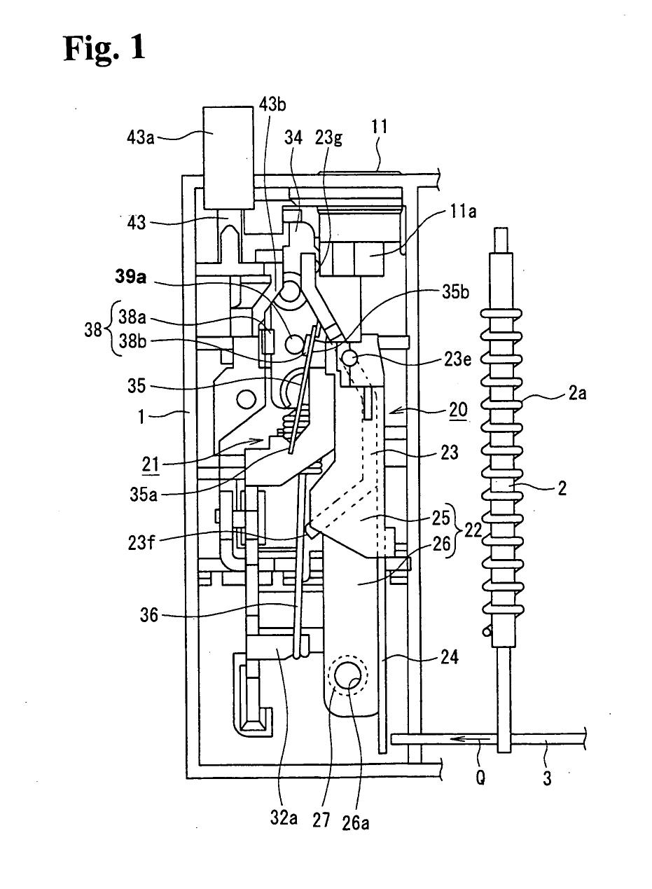

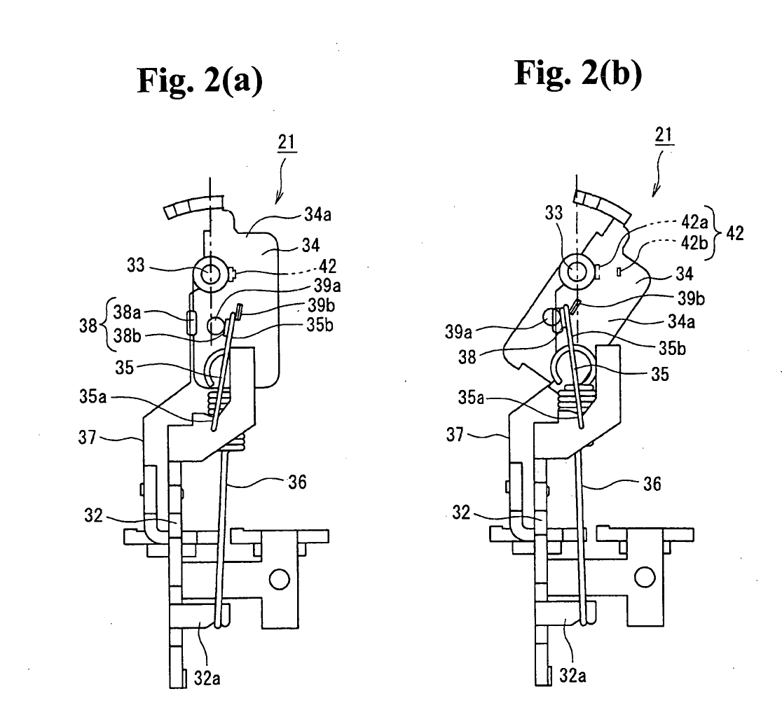

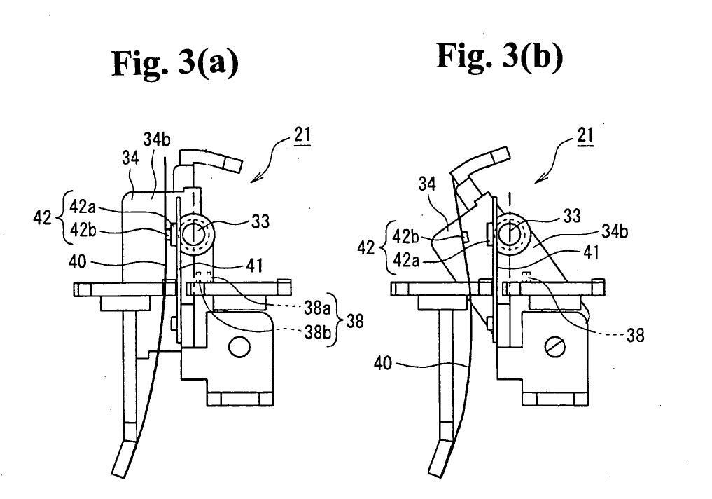

FIGS. 1 through 3 show an embodiment of a thermal overload relay according to the invention. FIG. 1 is a drawing showing essential parts in a normal state of a thermal overload relay according to the present invention; FIG. 2(a) is a drawing showing the contact reversing mechanism including a normally opened contact (a-contact) in the normal state; FIG. 2(b) is a drawing showing the contact reversing mechanism including the normally opened contact (a-contact) in a tripped state; FIG. 3(a) is a drawing showing the contact reversing mechanism including a normally closed contact (b-contact) in the normal state; and FIG. 3(b) is a drawing showing the contact reversing mechanism including the normally closed contact (b-contact) in a tripped state.

In the thermal overload relay of this embodiment, as shown in FIG. 1, in the insulator case 1 disposed are an adjusting mechanism 20 that works according to displacement of a shifter 3 linked to a free end of the main bimetals 2, a contact reversing mechanism 21 that changes-over contacts by an action of the adjusting mechanism 20, and a reset bar 43 for resetting the contact reversing mechanism 21.

The adjusting mechanism 20 comprises an adjusting link 22, a release lever 23 rotatably supported by the adjusting link 22, and a temperature compensation bimetal 24 fixed to the release lever 23 and linked to the shifter 3.

The adjusting link 22 is composed of a link support 25 supporting the release lever 23 and a leg part 26 extending downwards from one side of the link support 25.

A support shaft 27 is provided protruding from the inner wall at the lower part of the insulator case 1 into inside of the insulator case 1. A tip of the support shaft 27 having a reduced diameter is inserted into the bearing hole 26a of the leg part 26 and the whole adjusting link 22 is supported rotatably around the support shaft 27 of the insulator case 1.

The release lever 23 is provided with a rotating shaft 23e rotatably supported by a link support 25 of the adjusting link 22, and a reversing spring pushing part 23f formed in the portion of the release lever lower than the rotating shaft 23e, and a cam contacting part 23g is formed in the upper portion. The top end of a temperature compensation bimetal 24, a free end of which is located in a lower position, is fixed to the release lever 23.

The contact reversing mechanism 21 comprises, as shown in FIG. 2(a), a reversing mechanism support 32 disposed in the insulator case 1, an interlock plate 34 disposed in the vicinity of the reversing mechanism support 32 and rotatably supported on a support shaft 33 formed on the inner wall of the insulator case 1, a movable plate 35 with the upper portion 35b thereof disposed swingably around the lower portion 35a of the movable plate abutting on the reversing mechanism support 32. Further, a reversing spring 36 in the form of a tension coil spring is stretched between a coupling hole (not shown in the figure) formed in the side of the upper portion 35b of the movable plate 35 and a spring support 32a formed in the part of the reversing mechanism support 32 lower than the lower portion 35a of the movable plate 35.

The interlock plate 34 has a first linking pin 39a and a second linking pin 39b capable of linking with the movable plate 35 in the side of front surface 34a of the interlock plate 34. The first and second linking pins 39a and 39b induce the interlock plate 34 to rotate around the support shaft 33 in the reversing operation and the returning operation of the movable plate 35.

A normally opened contact (a-contact) side leaf spring 37 is provided on the reversing mechanism support 32 so that the free end of the normally opened contact (a-contact) side leaf spring 37 extends upwards. A fixed contact piece 38a of the a-contact 38 is fixed on the free end side of this leaf spring 37. A movable contact piece 38b, which is arranged to contact the fixed contact piece 38a, of the a-contact 38, is fixed on the upper portion 35b of the movable plate 35.

As shown in FIG. 3(a), on the back surface side 34b with respect to the intervening interlock plate 34, a normally closed contact (b-contact) side leaf spring 40 is disposed so that the free end thereof extends upwards. A contact support plate 41 is disposed facing this leaf spring 40. The movable contact piece 42b of the b-contact 42 is fixed on the free end side of the leaf spring 40, and the fixed contact piece 42a of the b-contact 42 to be connected to the movable contact piece 42b is fixed on the contact supporting plate 41.

The reset bar 43 comprises, as shown in FIG. 1, a reset button 43a that is manually pressed into the insulator case 1 and an angled surface 43b for returning the movable plate 35 that is in contact with the a-contact side leaf spring 37 and in a tripped state as shown in FIG. 2(b) to the initial position (normal state).

Now, operation of the thermal overload relay of the embodiment will be described.

When the main bimetal 2 is bent with the heat generated in the heater 2a by an overcurrent, displacement of the free end of the main bimetal 2 displaces the shifter 3 in the direction of arrow Q indicated in FIG. 1. When the free end of the temperature compensation bimetal 24 is pushed by the displaced shifter 3, the release lever 23 joined to the temperature compensation bimetal 24 rotates clockwise around the rotating shafts 23d, 23e supported by the adjusting link 22 and the reversing spring pushing part 23f of the release lever 23 pushes the reversing spring 36.

Due to the rotation of the release lever 23 in the clockwise direction, at the moment the pushing force of the reversing spring biasing part 23f exceeds the spring force of the reversing spring 36, the movable plate 35 starts to perform a reversing action around the lower part 35a. Accompanying the reversing action of the movable plate 35, the interlock plate 34, receiving the reversing action of the movable plate 35 transmitted through the first linking pin 39a, rotates around the support shaft 33 (see FIG. 2(b) and FIG. 3(b)).

As a result, the fixed contact piece 38a and the movable contact piece 38b of the a-contact 38 in the opened state shown in FIG. 2(a) are connected together, and the fixed contact piece 42a and the movable contact piece 42b of the b-contact 42 in the closed state as shown in FIG. 3(a) are separated away. Based on the information of the a-contact 38 and the b-contact 42, the electromagnetic contactor (not illustrated) is opened to interrupt the overcurrent in the main circuit.

Then, in the situation when the main bimetal 2 returns to the original configuration from the bent state after interruption of the main circuit current, the reset button 43a is pushed-in. With this manual reset operation of the reset bar 43, the angled surface 43b of the reset bar 43 exerts a resetting force through the a-contact side leaf spring 37 on the movable plate 35 in the tripped state shown in FIG. 2(b), thereby returning the movable plate 35 to the position of the initial state and at the same time, returning the interlock plate 34 to the position of the initial state (normal state) through the second linking pin 39b. Thus, the thermal overload relay is reset.

Now, effects of the thermal overload relay of the embodiment will be described.

In the contact reversing mechanism 21 of the embodiment, the a-contact 38 and the b-contact 42 are changed-over by rotation of the interlock plate 34 and the movable plate 35, and disposed in the vicinity of the front surface 34a side and the back surface 34b side of the interlock plate 34. Therefore, the space for placing the a-contact 38 and the b-contact 42 in the insulator case 1 is significantly reduced as compared with a conventional device, achieving size reduction of a thermal overload relay.

In addition, even if external disturbances such as vibration and shock come into the thermal overload relay, the movable contact piece 42b of the b-contact 42 in the closed state in the normal state shown in FIG. 3(a) is effectively never separated from the fixed contact piece 42a, preventing the contact from malfunctioning.

The movable contact piece 38b of the a-contact 38 is provided on the upper portion 35b of the movable plate 35 and change-over operation of the a-contact 38 is conducted with the reversing action of the movable plate 35. Consequently, the number of parts of the thermal overload relay is reduced, and in addition, the space for disposition of the a-contact 38 is decreased, thereby further reducing the size of the thermal overload relay.

In the embodiment described thus far, the a-contact 38 is changed-over by the reversing action of the movable plate 35. The reversing action of the movable plate 35, however, can change-over the b-contact.

The disclosure of Japanese Patent Application No. 2009-079396 filed on Mar. 27, 2009 is incorporated as a reference.

While the invention has been explained with reference to the specific embodiments of the invention, the explanation is illustrative and the invention is limited only by the appended claims.

What is claimed is:

1. A thermal overload relay comprising:
a case;
main bimetals which bend upon detection of an overload current;
a release lever rotating in accordance with a displacement of a shifter that is displaced in response to the bending of the main bimetals; and
a contact reversing mechanism for changing-over contacts responsive to a rotation of the release lever;
the main bimetals, the release lever and the contact reversing mechanism being disposed in the case, and
wherein the contact reversing mechanism comprises:
a movable plate supported at a support point at a first end thereof and swingably at a second end;
a reversing spring stretched between the second end of the movable plate and a spring support, the second end of the movable plate and the spring support being positioned opposite each other with respect to the support point, and reversing the movable plate by coupling with a rotated release lever; and
an interlock plate rotating around a support shaft together with movement of the movable plate; and
wherein each of the contacts has a normally opened contact piece and a normally closed contact piece and is disposed respectively in a vicinity of a front surface and in a vicinity of a back surface of the interlock plate.

2. The thermal overload relay according to claim 1, wherein one of the normally opened contact piece and the normally closed contact piece comprises a movable contact piece on an opposite side of the movable plate, and a change-over of the movable contact piece and the fixed contact piece is conducted by transmitting rotation of the interlock plate to the movable plate as a load for reversing action.
